(19) United States
(12) Patent Application Publication
(10) Pub. No.: US 2015/0220962 A1
(43) Pub. Date: Aug. 6, 2015

(54) CONSUMER REWARDS PLATFORM FEATURING VARIABLE CASH BACK REWARDS BASED ON TIME OF DAY

(71) Applicant: MOGL LOYALTY SERVICES, INC., San Diego, CA (US)

(72) Inventors: Jon David CARDER, San Diego, CA (US); Jarrod William CUZENS, Carlsbad, CA (US)

(21) Appl. No.: 14/606,998

(22) Filed: Jan. 27, 2015

Related U.S. Application Data
(60) Provisional application No. 61/934,536, filed on Jan. 31, 2014.

(51) Int. Cl. G06Q 30/02

(52) U.S. Cl. CPC G06Q 30/0235

(57) ABSTRACT

Disclosed are platforms, systems, media, and methods for providing a membership-based consumer rewards program wherein member consumers achieve rewards based on the time of day and day of week by conducting payment card transactions with business participating in the membership-based consumer rewards program during qualifying times and days.

### CROSS-REFERENCE TO RELATED APPLICATIONS

This application claims the benefit of U.S. application Ser. No. 61/934,536, filed Jan. 31, 2014, which is hereby incorporated by reference in its entirety.

### BACKGROUND OF THE INVENTION

Consumer rewards programs (also called loyalty programs) are structured marketing efforts that reward, and therefore encourage, loyal buying behavior by consumers. Traditional rewards programs utilize a card, visually similar to a credit card or debit card, which identifies a card holder as a member in the program. By presenting the card, a consumer is typically entitled to either a discount on the current purchase, or an allotment of points that can be used for future purchases.

### SUMMARY OF THE INVENTION

Many types of businesses are subject to variability in patronage over the course a calendar year, a month, a week, or a day. In some cases, special events draw large crowds at specific times and patronage falls back to normal as soon as the event concludes. In the case of restaurants, over the course of a typical week, consumers are more likely to dine out on weekends rather than weekdays. Moreover, in the case of restaurants, the typical day is punctuated by bursts of heavy business at meal times interspersed with periods of relatively slow business.

Existing consumer rewards programs fail to address variability in patronage over time, particularly, variability in patronage over the course of a day. Current technologies do not offer business owners the ability to dynamically configure rewards, particularly cash back rewards, to be higher during slow periods and lower (or eliminated) during peak demand. Moreover, current technologies do not offer consumers, for example, the ability to locate nearby businesses participating in their consumer rewards program, the ability to view a list of business currently offering a cash back reward that is sorted by cash back percentage, or the ability to view the schedule of cash back rewards that each business will offer over the course of a day.

Advantages of the platforms, systems, media, and methods described herein include offering business owners the option of configuring rewards based on the time of day. In other words, a business owner may, using the subject matter described herein, configure rewards that vary in magnitude for each time period during a day, day during a week, etc. These features alleviate the variability in patronage over time that challenge some businesses by creating consumer incentives that rise and fall inversely with demand. Further advantages include offering consumers the ability to quickly find business currently offering them rewards, maximize their reward by helping them to identify the highest level of reward currently offered in their area, and determine when high level rewards will be offered at their preferred business locations.

In one aspect, disclosed herein are consumer rewards platforms comprising: a mobile processor configured to provide a mobile application comprising: a software module for determining the location of a member consumer and transmitting the location to a server application; a software module for providing an interface to present one or more businesses participating in a membership-based consumer rewards program, the businesses located within a pre-determined distance from the member consumer and currently offering a reward based on the time of day and day of week to member consumers, the interface presented as a list, sorted by magnitude of reward, or a map; a server processor configured to provide a server application comprising: a software module for providing an interface to allow a business participating in the membership-based consumer rewards program to configure a plurality of rewards based on the time of day and day of week, each reward having a day, a start time, and end time, and a magnitude; a software module for receiving the location of a member consumer and determining one or more businesses participating in the membership-based consumer rewards program, located within a pre-determined distance from the member consumer, and currently offering a reward based on the time of day and day of week to member consumers; and a software module for querying payment card transaction data to identify a transaction between a member consumer and a business participating in the membership-based consumer rewards program that qualifies the member consumer for a reward. In some embodiments, the reward is a cash back reward. In further embodiments, the magnitude is a percentage of cash back. In still further embodiments, the percentage of cash back is about 5% to about 50%. In some embodiments, the pre-determined distance is about 1 mile to about 25 miles. In some embodiments, the interface to present one or more businesses participating in the membership-based consumer rewards program comprises a current reward for each business, the current reward comprising a magnitude and an end time. In some embodiments, the server application further comprises a software module for enrolling consumers in the membership-based consumer rewards program and registering one or more payment cards associated with each consumer. In some embodiments, the server application further comprises a software module for transacting a reward to a member consumer qualified for the reward based on the payment card transaction data. In some embodiments, the interface to allow a business participating in the membership-based consumer rewards program to configure a plurality of rewards is presented in the form of a calendar.

In another aspect, disclosed herein are computer-implemented systems comprising: a mobile processing device comprising an operating system configured to perform executable instructions and a memory device; a mobile application including instructions executable by the mobile processing device to create an application comprising: a software module for determining the location of a member consumer; a software module for presenting one or more businesses participating in a membership-based consumer rewards program, the businesses located within a pre-determined distance from the member consumer and currently offering a reward based on the time of day and day of week to member consumers, the interface presented as a list, sorted by magnitude of reward, or a map; and a software module for receiving a reward, the reward determined by querying payment card transaction data to identify a transaction between a member consumer and a business participating in the membership-based consumer rewards program that qualifies the member consumer for a reward based on the time of day and day of week of the transaction. In some embodiments, the reward is a cash back reward. In further embodiments, the magnitude is a percentage of cash back. In still further embodiments, the percentage of cash back is about 5% to about 50%. In some embodiments, the pre-determined distance is about 1 mile to about 25 miles.

In another aspect, disclosed herein are non-transitory computer-readable storage media encoded with a mobile application including instructions executable by a processor to create a mobile application comprising: a software module for determining the location of a member consumer; a software module for presenting one or more businesses participating in a membership-based consumer rewards program, the businesses located within a pre-determined distance from the member consumer and currently offering a reward based on the time of day and day of week to member consumers, the interface presented as a list, sorted by magnitude of reward, or a map; a software module for receiving a reward, the reward determined by querying payment card transaction data to identify a transaction between a member consumer and a business participating in the membership-based consumer rewards program that qualifies the member consumer for a reward based on the time of day and day of week of the transaction.

In another aspect, disclosed herein are computer-implemented systems comprising: a server comprising an operating system configured to perform executable instructions and a memory device; a computer program including instructions executable by the server to create an application comprising: a software module for providing an interface to allow a business participating in a membership-based consumer rewards program to configure a plurality of rewards based on the time of day and day of week, each reward having a day, a start time, and end time, and a magnitude; a software module for receiving the location of a member consumer and determining one or more businesses participating in the membership-based consumer rewards program, the businesses located within a pre-determined distance from the member consumer and currently offering a reward based on the time of day and day of week to member consumers; and a software module for querying payment card transaction data to identify a transaction between a member consumer and a business participating in the membership-based consumer rewards program that qualifies the member consumer for a reward. In some embodiments, the reward is a cash back reward. In further embodiments, the magnitude is a percentage of cash back. In still further embodiments, the percentage of cash back is about 5% to about 50%. In some embodiments, the pre-determined distance is about 1 mile to about 25 miles.

In another aspect, disclosed herein are non-transitory computer-readable storage media encoded with a computer program including instructions executable by a processor to create an application comprising: a database, in a computer memory, of member consumers and businesses participating in a membership-based consumer rewards program, each member consumer associated with one or more payment cards; a software module for providing an interface to allow the business participating in the membership-based consumer rewards program to configure a plurality of rewards based on the time of day and day of week, each reward having a day, a start time, and end time, and a magnitude; a software module for receiving the location of a member consumer and determining one or more businesses participating in the membership-based consumer rewards program, the businesses located within a pre-determined distance from the member consumer and currently offering a reward based on the time of day and day of week to member consumers; and a software module for querying payment card transaction data to identify a transaction between a member consumer and a business participating in the membership-based consumer rewards program that qualifies the member consumer for a reward.

### BRIEF DESCRIPTION OF THE DRAWINGS

FIG. 1 shows a non-limiting example of a process flow diagram; in this case, a diagram including steps for administering a membership-based consumer rewards program described herein.

FIG. 2 shows a non-limiting example of a consumer mobile application; in this case, an application including a user interface for presenting search results for nearby businesses participating in a consumer rewards program and offering cash back rewards based on time of day.

FIG. 3 shows a non-limiting example of a consumer mobile application; in this case, an application including a user interface for presenting details for a particular nearby business including a schedule of cash back rewards based on time of day.

FIGS. 4A and 4B show non-limiting examples of a consumer mobile application; in this case, an application including a user interface for presenting a map view of nearby businesses participating in a consumer rewards program (FIG. 4A) and offering cash back rewards based on time of day (FIG. 4B).

FIG. 5 shows a non-limiting example of a consumer web site; in this case, a web site including a user interface for presenting search results for nearby businesses participating in a consumer rewards program and offering cash back rewards based on time of day.

FIG. 6 shows a non-limiting example of a business owner dashboard; in this case, a dashboard including features allowing a business owner to configure cash back rewards based on time of day by customizing the percentage of cash back, the start time, and the end time for each reward.

### DETAILED DESCRIPTION OF THE INVENTION

Described herein, in certain embodiments, are consumer rewards platforms comprising: a mobile processor configured to provide a mobile application comprising: a software module for determining the location of a member consumer and transmitting the location to a server application; a software module for providing an interface to present one or more businesses participating in a membership-based consumer rewards program, the businesses located within a pre-determined distance from the member consumer and currently offering a reward based on the time of day and day of week to member consumers, the interface presented as a list, sorted by magnitude of reward, or a map; a server processor configured to provide a server application comprising: a software module for providing an interface to allow a business participating in the membership-based consumer rewards program to configure a plurality of rewards based on the time of day and day of week, each reward having a day, a start time, and end time, and a magnitude; a software module for receiving the location of a member consumer and determining one or more businesses participating in the membership-based consumer rewards program, located within a pre-determined distance from the member consumer, and currently offering a reward based on the time of day and day of week to member consumers; and a software module for querying payment card transaction data to identify a transaction between a member consumer and a business participating in the membership-based consumer rewards program that qualifies the member consumer for a reward.

Also described herein, in certain embodiments, are computer-implemented systems comprising: a mobile processing device comprising an operating system configured to perform executable instructions and a memory device; a mobile application including instructions executable by the mobile processing device to create an application comprising: a software module for determining the location of a member consumer; a software module for presenting one or more businesses participating in a membership-based consumer rewards program, the businesses located within a pre-determined distance from the member consumer and currently offering a reward based on the time of day and day of week to member consumers, the interface presented as a list, sorted by magnitude of reward, or a map; and a software module for receiving a reward, the reward determined by querying payment card transaction data to identify a transaction between a member consumer and a business participating in the membership-based consumer rewards program that qualifies the member consumer for a reward based on the time of day and day of week of the transaction.

Also described herein, in certain embodiments, are non-transitory computer-readable storage media encoded with a mobile application including instructions executable by a processor to create a mobile application comprising: a software module for determining the location of a member consumer; a software module for presenting one or more businesses participating in a membership-based consumer rewards program, the businesses located within a pre-determined distance from the member consumer and currently offering a reward based on the time of day and day of week to member consumers, the interface presented as a list, sorted by magnitude of reward, or a map; a software module for receiving a reward, the reward determined by querying payment card transaction data to identify a transaction between a member consumer and a business participating in the membership-based consumer rewards program that qualifies the member consumer for a reward based on the time of day and day of week of the transaction.

Also described herein, in certain embodiments, are computer-implemented systems comprising: a server comprising an operating system configured to perform executable instructions and a memory device; a computer program including instructions executable by the server to create an application comprising: a software module for providing an interface to allow a business participating in a membership-based consumer rewards program to configure a plurality of rewards based on the time of day and day of week, each reward having a day, a start time, and end time, and a magnitude; a software module for receiving the location of a member consumer and determining one or more businesses participating in the membership-based consumer rewards program, the businesses located within a pre-determined distance from the member consumer and currently offering a reward based on the time of day and day of week to member consumers; and a software module for querying payment card transaction data to identify a transaction between a member consumer and a business participating in the membership-based consumer rewards program that qualifies the member consumer for a reward.

Also described herein, in certain embodiments, are non-transitory computer-readable storage media encoded with a computer program including instructions executable by a processor to create an application comprising: a database, in a computer memory, of member consumers and businesses participating in a membership-based consumer rewards program, each member consumer associated with one or more payment cards; a software module for providing an interface to allow the business participating in the membership-based consumer rewards program to configure a plurality of rewards based on the time of day and day of week, each reward having a day, a start time, and end time, and a magnitude; a software module for receiving the location of a member consumer and determining one or more businesses participating in the membership-based consumer rewards program, the businesses located within a pre-determined distance from the member consumer and currently offering a reward based on the time of day and day of week to member consumers; and a software module for querying payment card transaction data to identify a transaction between a member consumer and a business participating in the membership-based consumer rewards program that qualifies the member consumer for a reward.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Membership-Based Consumer Rewards Program

In some embodiments, the platforms, systems, media, and methods described herein provide a membership-based consumer rewards program, or use of the same. In further embodiments, the rewards are based on date and time and are provided to consumers for transactions completed within a configured window of time on a particular day. In some embodiments, participating business owners are provided with a computer interface allowing them to optionally configure rewards for member consumers, wherein each reward is configured to have a date, start time, end time, and magnitude. In some embodiments, member consumers download and utilize a mobile application to search for and find nearby businesses currently offering a reward, wherein the application sorts the businesses based on the magnitude of the rewards.

Many types of rewards are suitable for the membership-based consumer rewards programs described herein. In various embodiments, suitable rewards include, but are not limited to, airline points, reward points, VIP treatment, digital goods, and combinations thereof. In particular embodiments, the rewards are cash-back rewards. In other embodiments, the platforms, systems, media, and methods described herein provide users with the option to donate a reward to a charity or donate meals instead of receiving a reward.

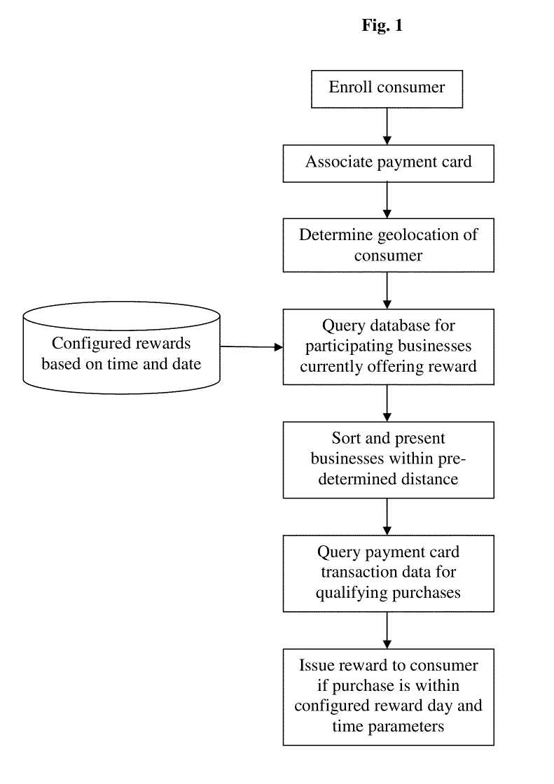

Referring to FIG. 1, in a particular embodiment, a process flow diagram for administering the membership-based consumer rewards programs described herein includes the steps of:

1) enrolling a plurality of consumers in the program, each of whom downloads and installs a particularly configured mobile application;

2) associating one or more payment cards with each enrolled consumer so that transactions qualifying a consumer for a reward can be identified;

3) determining the geolocation of a consumer, or more specifically the consumer's mobile processing device in response to the consumer's request for information;

4) querying a database to determine businesses participating in the consumer rewards program that are within a pre-determined distance of the consumer's location and are currently offering a date/time-based reward to incentivize patronage;

5) sorting the identified businesses based on magnitude of reward currently offered and presenting the businesses to the consumer in either a list or map form, wherein the presentation includes access to information about each business such as directions, hours, goods, services, etc.;

6) querying payment card transaction APIs to identify one or more transactions that are completed between a member consumer and a participating business and determining if the transaction qualifies the consumer for a reward based on the day and time; and

7) issuing the reward to the consumer, via their payment card, if the transaction is qualified.

Many types of payment cards are suitable for the membership-based consumer rewards programs described herein. In various embodiments, suitable payment cards include, but are not limited to credit cards, debit cards, pre-paid cards, loyalty cards, membership cards, and the like.

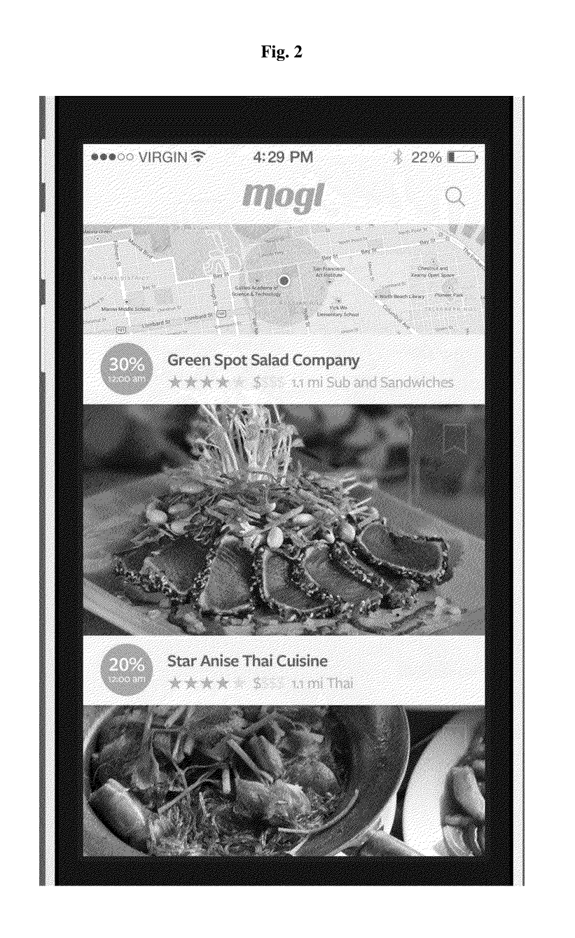

Referring to FIG. 2, in a particular embodiment, a consumer mobile application described herein includes a graphic user interface for presenting a list of businesses participating in the membership-based consumer rewards program, the businesses located within a pre-determined distance from the member consumer and currently offering a reward based on the time of day and day of week to member consumers. In this embodiment, each business is represented in the interface by name, photos, distance, and a current reward comprising a magnitude (e.g., a percent cash back) and an end time. Further in this embodiment, the list is sorted by magnitude of reward such that the highest reward offer is presented at the top of the list. The list suitably includes any number of businesses such as about 1 to about 200 businesses.

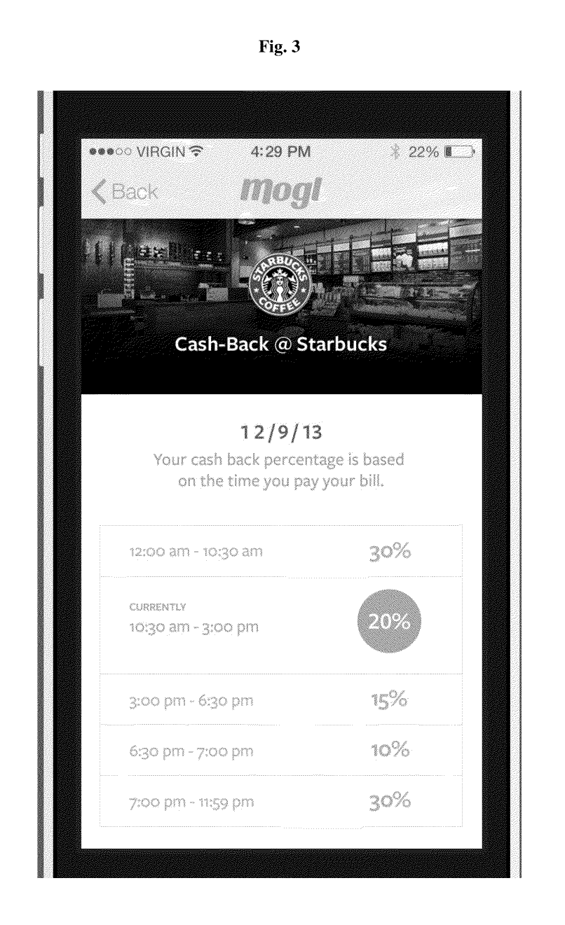

Referring to FIG. 3, in a particular embodiment, a consumer mobile application described herein includes a graphic user interface for presenting details of a particular participating business. In this embodiment, the details include name, photos, and a schedule of currently configured rewards based on date and time, each reward including a date, start time, end time, and magnitude (e.g., percent cash back).

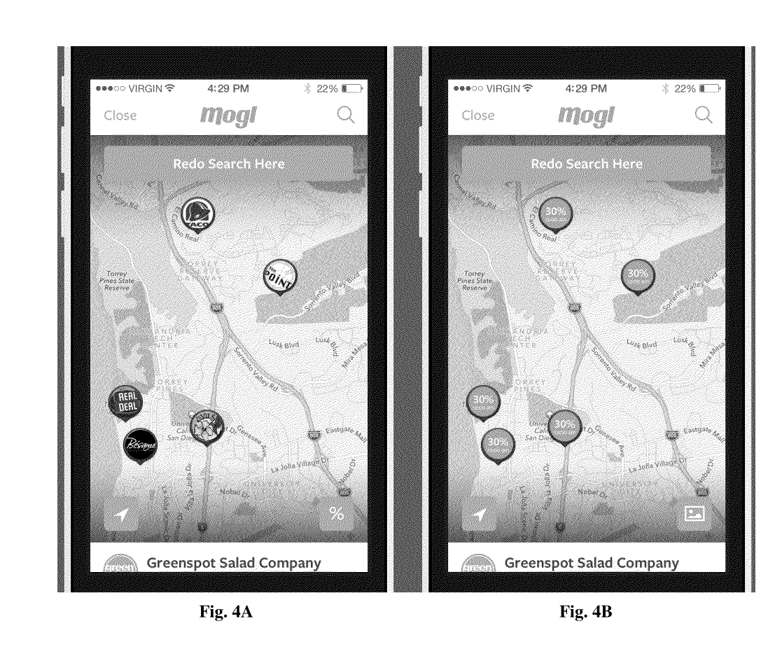

Referring to FIG. 4, in a particular embodiment, a consumer mobile application described herein includes a graphic user interface for presenting a map of businesses participating in the membership-based consumer rewards program, the businesses located within a pre-determined distance from the member consumer and currently offering a reward based on the time of day and day of week to member consumers. In this embodiment, each business is represented in the interface by a “pin” comprising either a logo or a reward, the reward comprising a magnitude and end time.

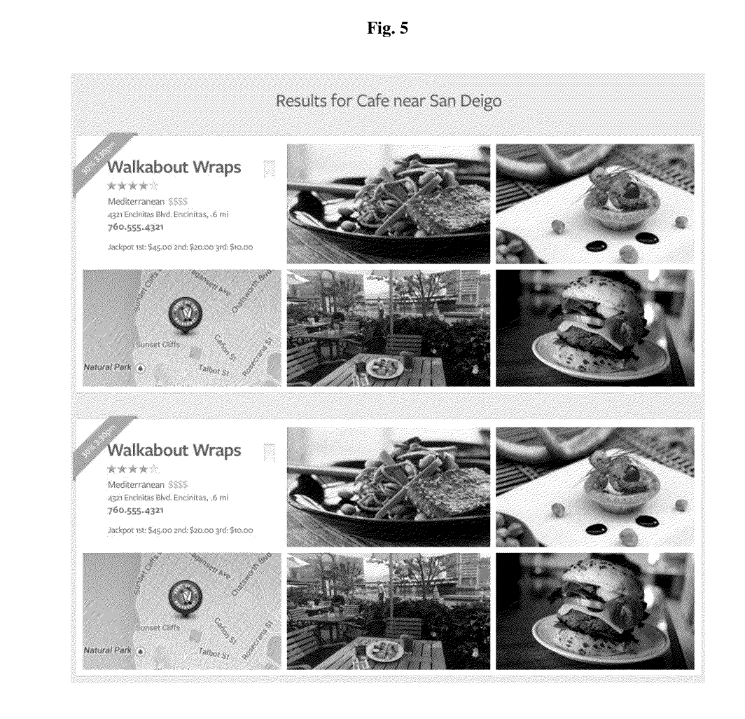

Referring to FIG. 5, in a particular embodiment, a consumer web site described herein includes a graphic user interface for presenting a list of businesses participating in the membership-based consumer rewards program, the businesses located within a pre-determined distance from the member consumer and currently offering a reward based on the time of day and day of week to member consumers. In this embodiment, each business is represented in the interface by name, photos, distance, and a current reward comprising a magnitude (e.g., a percent cash back) and an end time. Further in this embodiment, the list is sorted by magnitude of reward such that the highest reward offer is presented at the top of the list. The list suitably includes any number of businesses such as about 1 to about 200 businesses.

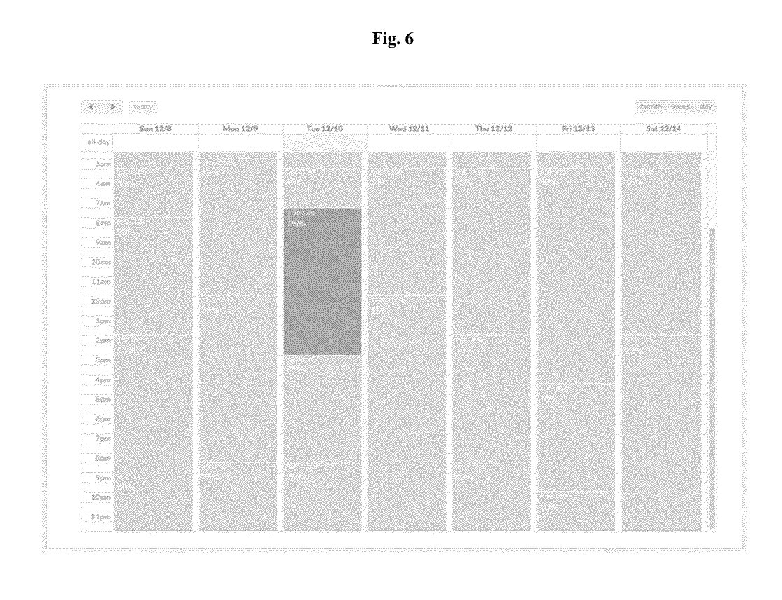

Referring to FIG. 6, in a particular embodiment, business owner application described herein includes a graphic user interface for allowing participating business owners to configure one or more rewards for member consumers completing purchase transactions at their business. In this embodiment, the interface is in the form of a calendar with month, week, and day views. Further in this embodiment, each reward is represented on the calendar by a non-overlapping block of time. Each reward includes a date, a start time, and end time, and a magnitude. In this case, the rewards are cash back rewards and the magnitude is expressed as a percentage cash back. In some embodiments, the business owner application is a web application. In other embodiments, the business owner application is a mobile application.

### Geolocation

Geolocation is the identification of the real-world geographic location of an object, such as a computer, mobile smartphone, or a portable computing device such as a laptop or tablet computer. A location is suitably expressed in a number of ways including, by way of non-limiting examples, geographic coordinates (e.g., latitude and longitude), a place name (e.g., county, city, landmark, intersection, etc.), a physical street address, distance from a given location, presence within a specified radius from a given location, and a graphical depiction on a map. In some cases, geolocation involves geocoding to find associated latitude and longitude from other geographic data. In some cases, geolocation involves reverse geocoding to back code latitude and longitude coordinates to a readable address or place name.

Many methods of geolocation are suitable that utilize several underlying sources of location information. In some embodiments, a software module geolocates, for example, a consumer, a mobile processing device, a retail item, or a physical retail outlet using sources of location information including, by way of non-limiting examples, GPS coordinates provided by a processing device, triangulation between mobile phone towers and public masts (e.g., assistive GPS), Wi-Fi connection location, WHOIS performed on IP address or MAC address (e.g., Wi-Fi base station MAC address), GSM/CDMA cell IDs (e.g., identification, triangulation, and multilateration), and location information self-reported by a user. In some embodiments, location information includes position (e.g., latitude and longitude), elevation, heading, speed, orientation, and combinations thereof.

In some embodiments, a software module geolocates, for example, a consumer, a mobile processing device, or a business by using the HTML 5 geolocation API. In light of the disclosure provided herein, those of skill in the art will recognize that the HTML 5 geolocation API is supported in Internet Explorer 9.0+, Firefox 3.5+, Safari 5.0+, Chrome 5.0+, Opera 10.6+, iOS 3.0+, Android 2.0+, and Windows Phone 7.5+. In some embodiments, a software module geolocates, for example, a consumer, a mobile processing device, or a business using methods aligned with W3C Geolocation API (available at: http://dev.w3.org/geo/api/spec-source.html). The W3C Geolocation API defines an interface to location information associated with a processing device (e.g., smartphone, tablet computer, laptop computer, etc.) hosting the implementation, such as latitude and longitude.

In some embodiments, the platforms, systems, media, and methods disclosed herein perform geolocation by one method, such as those disclosed herein. In other embodiments, the platforms, systems, media, and methods disclosed herein perform geolocation by more than one method.

In some embodiments, the geolocation of, for example, a consumer, a mobile processing device, or a business is accurate to within at least 100, 90, 80, 70, 60, 50, 40, 30, 20, 10, 9, 8, 7, 6, 5, 4, 3, 2, 1 or fewer kilometers, including increments therein. In further embodiments, the geolocation is accurate to within at least 1000, 900, 800, 700, 600, 500, 400, 300, 200, 100, 90, 80, 70, 60, 50, 40, 30, 20, 10, 9, 8, 7, 6, 5, 4, 3, 2, 1 or fewer meters, including increments therein.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of business and consumer location information, reward information, and the like. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Business Interface

The manager of a restaurant located in the downtown area of a major city contends with strong variability in patronage based on the day of the week and the time of day. The restaurant receives heavy patronage during the weekdays, especially during the lunch hour due to its proximity to several large office buildings. However, on weekends and after business hours, the restaurant has under-utilized capacity.

The restaurant manager registers to participate in a membership-based consumer rewards program that will allow her to incentivize patronage of the restaurant specifically in the off-hours. Using a proprietary web application, she creates an account, logs into a business interface, and configures a consumer percentage of cash back reward. She configures a consumer reward that is based on the time of day and the day of the week. For this reward, she enters a day (Sunday), a start time (7 AM), an end time (11 AM), a type (percent of cash back) and a magnitude (25% of cash back).

The configured consumer reward will be extended to participating consumers, via a mobile application, who are within about 10 miles of the restaurant on Sundays from 7 AM to 11 AM until the restaurant manager deactivates or otherwise alters the configured reward. The application monitors transaction data for the registered payment cards of participating consumers and scans for qualifying transactions with the restaurant. Those member consumers successfully taking advantage of the reward will receive a credit, via their payment card, for 25% of their bill.

### Example 2

### Consumer Interface

A cost-conscious consumer registers to participate in the membership-based consumer rewards program of Example 1. Using a proprietary mobile application, he creates an account, logs in, and registers his visa credit card with the program. When the consumer becomes hungry while shopping in the downtown area of his city, he uses a consumer interface of the mobile application to present a map of participating business currently offering rewards. In the map view of his application, he sees that five different restaurants within a 10 mile radius of his location are currently offering rewards. He configures the consumer interface to present a list view of the business currently offering rewards, filters the list to show only cash back rewards, and sorts the list by magnitude of reward. Because it is 10 AM on a Sunday morning the reward described in Example 1 is presented and because no other nearby restaurants are offering more than 20% cash back, the reward described in Example 1 is presented at the top of the list.

The consumer enjoys a meal at the restaurant described in Example 1. The application detects a transaction qualifying for the reward when he pays his check with his registered visa credit card and the consumer automatically receives a credit of 25% of his bill on his card.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A consumer rewards system comprising:
a. a mobile processor configured to provide a mobile application comprising:
i. a software module for determining the location of a member consumer and transmitting the location to a server application;
ii. a software module for providing an interface to present one or more businesses participating in a membership-based consumer rewards program, the businesses located within a pre-determined distance from the member consumer and currently offering a reward based on the current time of day and day of week to member consumers, the interface presented as a list, sorted by magnitude of reward, or a map;
b. a server processor configured to provide a server application comprising:
i. a software module for providing an interface to allow a business participating in the membership-based consumer rewards program to configure a plurality of rewards based on the time of day and day of week, each reward having a day, a start time, and end time, and a magnitude;
ii. a software module for receiving the location of a member consumer and determining one or more businesses participating in the membership-based consumer rewards program, located within a pre-determined distance from the member consumer, and currently offering a reward based on the time of day and day of week to member consumers; and
iii. a software module for querying payment card transaction data to identify a transaction between a member consumer and a business participating in the membership-based consumer rewards program that qualifies the member consumer for a reward.

2. The system of claim 1, wherein the reward is a cash back reward.

3. The system of claim 2, wherein the magnitude is a percentage of cash back.

4. The system of claim 3, wherein the percentage of cash back is 5% to 50%.

5. The system of claim 1, wherein the pre-determined distance is 1 mile to 25 miles.

6. The system of claim 1, wherein the interface to present one or more businesses participating in the membership-based consumer rewards program comprises a current reward for each business, the current reward comprising a magnitude and an end time.

7. The system of claim 1, wherein the server application further comprises a software module for enrolling consumers in the membership-based consumer rewards program and registering one or more payment cards associated with each consumer.

8. The system of claim 1, wherein the server application further comprises a software module for transacting a reward to a member consumer qualified for the reward based on the payment card transaction data.

9. The system of claim 1, wherein the interface to allow a business participating in the membership-based consumer rewards program to configure a plurality of rewards is presented in the form of a calendar.

10. A computer-implemented system comprising:
a. a mobile processing device comprising an operating system configured to perform executable instructions and a memory device;
b. a mobile application including instructions executable by the mobile processing device to create an application comprising:
i. a software module for determining the location of a member consumer;
ii. a software module for presenting one or more businesses participating in a membership-based consumer rewards program, the businesses located within a pre-determined distance from the member consumer and currently offering a reward based on the current time of day and day of week to member consumers, the interface presented as a list, sorted by magnitude of reward, or a map; and
iii. a software module for receiving a reward, the reward determined by querying payment card transaction data to identify a transaction between a member consumer and a business participating in the membership-based consumer rewards program that qualifies the member consumer for a reward based on the time of day and day of week of the transaction.

11. The system of claim 10, wherein the reward is a cash back reward.

12. The system of claim 11, wherein the magnitude is a percentage of cash back.

13. The system of claim 11, wherein the percentage of cash back is 5% to 50%.

14. The system of claim 10, wherein the pre-determined distance is 1 mile to 25 miles.

15. A computer-implemented system comprising:
a. a server comprising an operating system configured to perform executable instructions and a memory device;
b. a computer program including instructions executable by the server to create an application comprising:
i. a software module for providing an interface to allow a business participating in a membership-based consumer rewards program to configure a plurality of rewards based on the time of day and day of week, each reward having a day, a start time, and end time, and a magnitude;
ii. a software module for receiving the location of a member consumer and determining one or more businesses participating in the membership-based consumer rewards program, the businesses located within a pre-determined distance from the member consumer and currently offering a reward based on the current time of day and day of week to member consumers; and
iii. a software module for querying payment card transaction data to identify a transaction between a member consumer and a business participating in the membership-based consumer rewards program that qualifies the member consumer for a reward.

16. The system of claim 15, wherein the reward is a cash back reward.

17. The system of claim 16, wherein the magnitude is a percentage of cash back.

18. The system of claim 17, wherein the percentage of cash back is 5% to 50%.

19. The system of claim 15, wherein the pre-determined distance is 1 mile to 25 miles.

20. The system of claim 15, wherein the application further comprises a database, in a computer memory, of member consumers and businesses participating in the membership-based consumer rewards program, each member consumer associated with one or more payment cards.
